(19) United States
(12) Patent Application Publication
(10) Pub. No.: US 2015/0020895 A1
(43) Pub. Date: Jan. 22, 2015

(54) RELIEF VALVE

(71) Applicant: K-Pump Inc., Lake Oswego, OR (US)

(72) Inventor: James D. Kutella, Lake Oswego, OR (US)

(73) Assignee: K-Pump Inc., Lake Oswego, OR (US)

(21) Appl. No.: 13/947,848

(22) Filed: Jul. 22, 2013

(51) Int. Cl. F16K 15/20

(52) U.S. Cl. CPC F16K 15/20
USPC 137/224

(57) ABSTRACT

A relief valve is configured to fit between the outlet of a hand pump and the inlet of an inflatable device to prevent the inflatable device from being inflated beyond a desired pressure. The relief valve can also be used to bleed excess air out of an inflatable device that is above its desired pressure.

### BACKGROUND

Inflatable devices, such as rafts, paddle boards and surfboards, are designed to be inflated to a specific pressure and perform their best when inflated to that pressure. Typically, these devices are inflated on-site by use of a hand pump. It is common to provide a gauge on or in connection with the pump, however in the environment where these devices are used it is difficult to use a gauge to accurately inflate the device to the desired pressure, assuming that the person inflating the device even knows what the proper pressure is.

### SUMMARY OF THE INVENTION

A relief valve for placement between a source of pressurized air and an inflatable device includes a housing having an inlet configured to communicate with a source of pressurized air, an outlet configured to communicate with an inflatable device and an exhaust port located between the inlet and outlet. A valve associated with the exhaust port is movable between a closed position where pressurized air cannot escape from the housing and an open position where pressurized air can escape from the housing. The valve is biased to the closed position and moves to the open position when the air in the housing reaches a certain level. Thus, once the proper pressure is obtained in the inflatable device the valve prevents the user from inflating the device beyond that pressure.

The foregoing and other objectives, features, and advantages of the invention will be more readily understood upon consideration of the following detailed description taken in conjunction with the accompanying drawings.

### BRIEF DESCRIPTION OF THE SEVERAL DRAWINGS

FIG. 1 is a perspective view of a relief valve embodying the subject invention.

FIG. 2 is a perspective view of another embodiment of the invention.

FIG. 3 is an exploded view of the embodiment shown in FIG. 1.

FIG. 4 is a fragmentary sectional view showing a valve spring and a keeper which are elements of the invention.

FIG. 5 is a cross-sectional view showing the details of the relief valve.

FIG. 6 is a side elevational view showing how the relief valve is inserting into an inflatable device.

FIG. 7 is a side elevational view, partially broken away, of another embodiment of the invention.

### DETAILED DESCRIPTION OF PREFERRED EMBODIMENTS

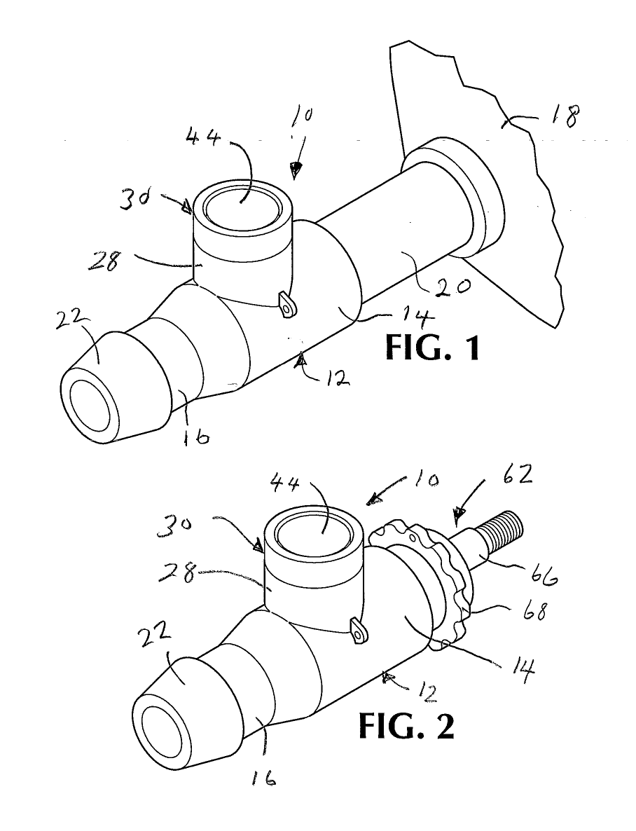

Referring now to FIGS. 1 and 6 of the drawings, a relief valve 10 includes a housing 12 having an inlet 14 and an outlet 16. Preferably the housing is an integral unit made from injection molded plastic, such as PVC. In the embodiment shown in FIGS. 1, and 4 through 6, the relief valve is configured to be used with a hand pump 18 having a circular cross-sectioned cylindrical outlet 20. Pumps of this type are made by K-Pump of Lake Oswego, Oregon. A typical pump of this type is disclosed in U.S. Pat. No. 7,353,746. The inlet 14 of the housing is a circular cross-sectioned cylinder having an inside diameter equal to or slightly greater than the outside diameter of the pump outlet 20. The outlet 16 of the housing is also a circular cross-sectioned cylinder. An elastomeric adapter 22 has one end which fits over the outlet 16 of the housing. The other end of the adapter is configured to be pushed into an inlet 24 in an inflatable device 26, FIG. 6. Different adapters can be provided for different inflatable devices.

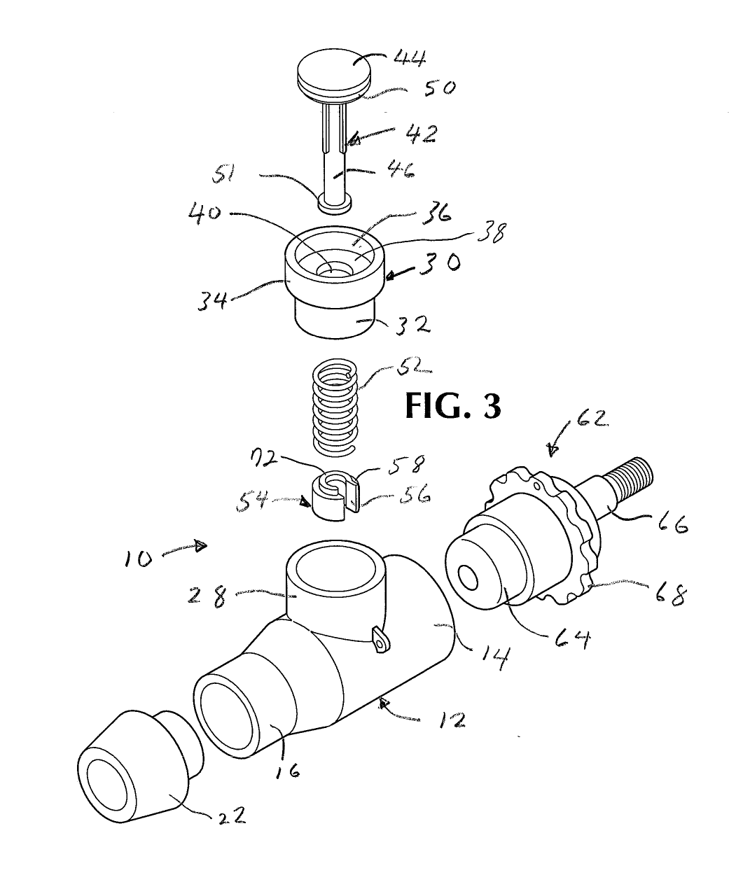

The housing 12 also contains an exhaust port 28 which is located between the inlet 14 and the outlet 16. In the embodiment shown in the drawings, the inlet 14 and outlet 16 have a common axis, and the axis of the exhaust port is perpendicular to this common axis. This symmetry facilitates injection molding but other configurations would work as well. The exhaust port is a circular cross-sectioned cylinder. Referring now to FIGS. 3, 4 and 5, a valve seat 30 is located in the exhaust port 28. As will be explained more fully later, the valve seat is a separate element from the housing 12 and is adhered to the housing by an adhesive. The valve seat 30 is cylindrical and has a T-shaped cross-section. The base 32 of the T has an outside diameter which is slightly less than the inside diameter of the exhaust port 28. The head 34 of the T has an outside diameter which is the same as the outside diameter of the exhaust port 28. Thus, when the base 32 of the valve seat is inserted into the exhaust port, the head of the valve seat appears to be an extension of the exhaust port. A cavity 36 located in the head 34 has a flat bottom surface 38. A hole 40 extends centrally through the valve seat.

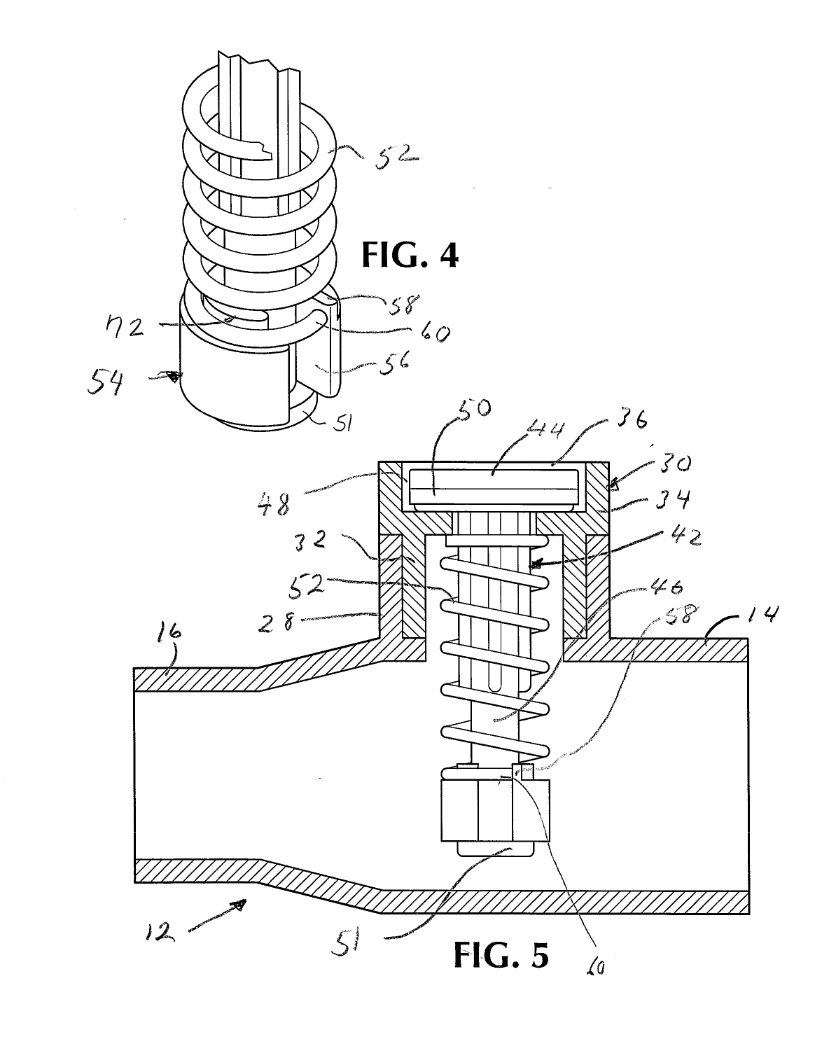

Located in the valve seat is a valve 42 having a cylindrical head 44 and a shaft 46 which extends perpendicularly from the head. The head is configured to fit in the cavity 36 of the valve seat and the shaft fits through the hole 40 and extends out of the valve seat into the housing 12. The outside diameter of the head 44 is slightly less than the inside diameter of the cavity leaving an angular space 48 between them. An elastomeric pad 50 fits over the stem 46 and rests against the bottom surface of the head 44. The bottom portion of the shaft is circular in cross-section and it has a larger diameter cylindrical stop 51 located at its end. A compression spring 52 fits over the stem 46. One end of the spring 52 abuts the underside of the bottom of the cavity 36. The other end of the spring abuts a keeper 54 which is attached to the shaft 46. The distance between the bottom of the cavity and the keeper is less than the relaxed length of the spring thereby causing the spring to be compressed. The keeper 54 is a circular cross-sectioned cylinder having an inside diameter which is slightly greater than the outside diameter of the shaft 46 but is less than the diameter of the stop 51. The outside diameter of the keeper is larger than the diameter of the spring 52. An angular ridge 72 projects upwardly from the top of the keeper. The ridge 72 has an outside diameter which is slightly less than the inside diameter of the spring. A gap 56 is located in the keeper. The width of the gap is slightly less than the diameter of the shaft 46. The keeper is flexible enough that it can be opened slightly to place it over the shaft, but will return to its relaxed position and become attached to the shaft. This allows the valve 42 to be inserted into the hole 40 in the valve seat and the spring 52 placed over the protruding shaft 46. The spring is then compressed and the keeper is inserted on the shaft between the compressed spring and the stop. When the spring is relaxed it pushes the keeper against the stop 51. The greater the length of the keeper the more the spring is compressed. This allows having the valve open at different pressures depending upon its application. Referring to FIGS. 4 and 5, the keeper 54 has a projecting tab 58 located adjacent to one side of the gap 56, which is used to index the keeper relative to the spring 52. The end 60 of the spring is stepped upwardly from the preceding coil so how the gap 56 in the keeper 54 is oriented rotationally relative to the spring affects the effective length of the keeper, and thus the amount the spring is compressed. By rotating the keeper relative to the spring until the end 60 of the spring contacts the tab 58, FIGS. 4 and 5, the keeper is always in the same location rotationally on the spring, and thus the same spring compression is obtained. Once the spring 52 is installed on the valve 42, the valve seat 30 is inserted into and adhesively attached to the exhaust port 28.

Referring now to FIGS. 2 and 3, a converter 62 allows the relief valve to be filled with air from a compressor or tank rather than from a hand pump. The converter has base 64 which can be inserted into the inlet 14. An opening extends through the converter and a SCHRADER™ valve 66 extends through this hole. A grip ring 68 surrounds the converter to allow it to be twisted easily to remove it from the inlet 14.

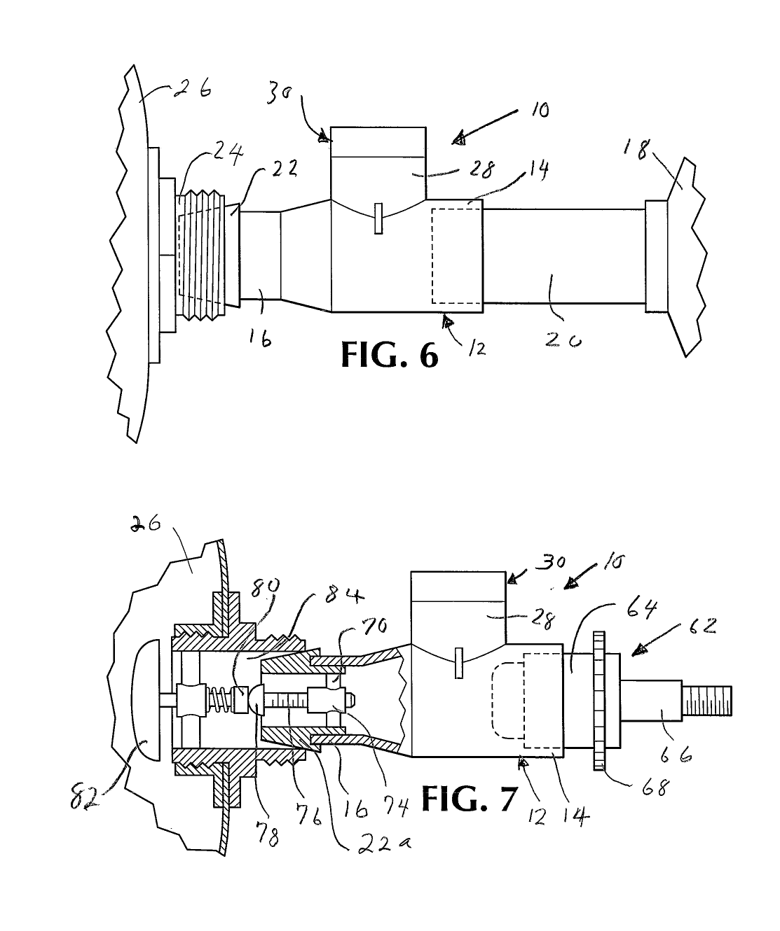

When an inflatable device is filled to a desired pressure and then the ambient temperature increases, or the device sits in the sun, the air in the device expands as it becomes warmer and the pressure increases. When this occurs air needs to be bled from the inflatable device to return it to the proper pressure. Referring now to FIG. 7, a specific adapter 22a is used to bleed excess air out of the inflatable device. The adapter 22a has a bridge 70 extending across its interior. A turret 72 located in the center of the bridge 70 has a threaded hole extending through it coaxially with the axes of the inlet 14 and outlet 16. A screw 76 having a head 78 is threaded into the hole in the turret. The head of the screw typically is located outside of the adapter 22a. The screw is configured to contact the valve stem 80 of the inlet valve 82 in the inflatable device 26 and open the inlet valve 82 when the adapter 22a is inserted into the opening 84 of the inflatable device. If the inlet 14 of the housing 12 is plugged with the connector 62, air from the inflatable device fills the housing 12. The valve 42 then opens and air is bled out of the inflatable device until the proper pressure is obtained and the valve closes. As a result, the relief valve 12 becomes a quick and easy way to bleed excess pressure from an inflatable device. The screw 76 is adjustable in the turret 72 in order for it to contact the valve stem on different inflatable devices.

What is claimed is:

1. A relief valve for placement between a source of pressurized air and an inflatable device, comprising:
(a) a housing having an inlet configured to communicate fluidly with a source of pressurized air and an outlet configured to communicate fluidly with an inlet in an inflatable device;
(b) an exhaust port located in said housing between said inlet and said outlet;
(c) a valve associated with said exhaust port, said valve being movable between a closed position where pressurized air in said housing cannot escape through said exhaust port and an open position where pressurized air in said housing can escape through said exhaust port;
(d) said valve being biased to said closed position until the pressure in said housing reaches a predetermined level.

2. The relief valve of claim 1 wherein said source of pressurized air is a hand pump having a circular cross-sectioned cylindrical outlet, said inlet being a circular cross-sectioned cylinder that matingly receives said cylindrical outlet.

3. The relief valve of claim 1 further comprising:
(a) said valve having a head and a shaft which extends perpendicular from said head;
(b) a compression spring which surrounds said shaft;
(c) a stop located at a distal end of said shaft;
(d) a keeper which releasably attaches to said stop;
(e) a spring which fits over said shaft and extends between said head and said keeper;
(f) said spring being compressed between said head and said keeper.

4. The relief valve of claim 3 wherein said keeper includes a tab which is configured to allow positioning said keeper in the desired rotational position relative to said spring.

5. The relief valve of claim 3 wherein said keeper has a length which determines the amount which said spring is compressed.

6. The relief valve of claim 3 including a converter comprising:
(a) a base which fits into said inlet in said housing; and
b) a SCHRADER™ valve which extends through said converter such that pressurized air inserted into said SCHRADER™ valve flows into said housing.

7. The relief valve of claim 1 including an elastomeric adapter which removably fits over said outlet of said housing, said adapter configured to engage the inlet in said inflatable device.

8. The relief valve of claim 7 including:
(a) a plug which removably fits into said inlet of said housing;
(b) a bridge which distends across said elastomeric adapter;
(c) a pin carried by said bridge, said pin configured to open a valve in said inflatable device when said housing is inserted into an air inlet on said inflatable device, thereby bleeding pressurized air from said inflatable device and into said housing.

9. The relief valve of claim 8 wherein the location of said pin in said bridge is adjustable.
